(19) United States
(12) Patent Application Publication
(10) Pub. No.: US 2024/0141184 A1
(43) Pub. Date: May 2, 2024

(54) SPRAYABLE TEXTURE COATING COMPOSITIONS AND METHODS OF APPLICATION

(71) Applicant: Transtar Autobody Technologies LLC, Walton Hills, OH (US)

(72) Inventors: Sanford G. Mitchell, III, Petersburg, MI (US); Nicholas Solomon, Fenton, MI (US); Brian Cauchi, Howell, MI (US); Nirali Lathia, Wixom, MI (US); Todd A. Seaver, Monroe, MI (US)

(21) Appl. No.: 18/385,621

(22) Filed: Oct. 31, 2023

Related U.S. Application Data
(60) Provisional application No. 63/420,944, filed on Oct. 31, 2022.

(51) Int. Cl. C09D 7/65; C09D 4/00; C09D 5/28; C09D 7/40; C09D 7/61; C09D 175/04

(52) U.S. Cl. CPC C09D 7/65; C09D 4/00; C09D 5/28; C09D 7/61; C09D 7/69; C09D 175/04

(57) ABSTRACT

One aspect described herein is a polyurethane, texture coating composition, sprayable on a substrate by means of conventional spray equipment and at conventional pressures and ambient temperatures, in one or more layers to a film thickness of up to about 30 mils, comprises a resin component having hydroxyl functionality, an isocyanate functional curing component, an organotin catalyst, a polyethylene wax particle and a silica particle. The composition may optionally include an extender pigment and a colorant. Advantageously, the coating compositions of the present invention provide polyurethane films with texture, having excellent physical properties, slip properties with abrasion resistance, solvent and UV resistance and adhesion to prepared substrates. The compositions are particularly useful to repair textured substrates, add desired textures to substrates and form sprayable vehicle bedliners.

### CROSS REFERENCES TO RELATED APPLICATIONS

The following application claims priority under 35 U.S.C. § 119(e) to co-pending U.S. Provisional Patent Application Ser. No. 63/420,944 filed Oct. 31, 2022 entitled SPRAYABLE TEXTURE COATING COMPOSITIONS AND METHODS OF APPLICATION. The above-identified application is incorporated herein by reference in its entirety for all purposes.

### TECHNICAL FIELD

The present disclosure relates generally to a curable coating comprising a sprayable polyurethane, texture coating compositions and associated methods of application thereof and, more specifically, curable coatings to repair and/or add textures to substrates.

### BACKGROUND

The use of plastic parts, especially on vehicles, has increased because plastic parts reduce weight, thus improving fuel economy, and increases resistance to corrosion, relative to metal. With increases in plastic use, there is an increased need to repair plastic parts after a collision, from the vehicle duty cycle, and/or from other wear from weathering. An increased use of textured anti-stone chip coatings in a rocker area of vehicles has increased the need to repair this area. The more economically demanding repair of metal parts for vehicles has, until recently, taken priority. Typically, in newer vehicles, damaged plastic parts are replaced with new plastic parts. Because of supply chain disruptions there is a shortage of replacement plastic parts, and/or a delay in their availability. To facilitate a timely repair, it has become preferable to repair a damaged plastic part whenever the nature of the damage allows.

Such plastic parts often have textures designed into them from a molding process that are visibly desirable and are to be returned to their original appearance during the repair. The standard processes for repairing, cuts, tears, scratches, weathering, and/or gouges in the damaged plastic parts, either due to a collision, duty cycle, and/or weathering disrupts the texture in the area of the damage.

Currently, sprayable polyurea, polyurethane and hybrid polyurethane/polyurea products are used in place of preformed, plastic inserts in the truck bed liner market. These sprayable products typically require that the components are mixed at high pressure, often in the range of 1000-2000 psi. Spray equipment that can handle such high pressure are costly to purchase and maintain for body shops, auto retailers. Further, auto detailers whose business is not dedicated to high pressure spray equipment would not have high enough volume to justify the equipment cost. There remains a need to improve the sprayable compositions and application process to reduce the overall application cost of these existing products, while maintaining the desired physical properties and appearance of textured coatings.

There is currently no sprayable curable coating that covers the damage, covers the repair, and restores the original molded texture of the plastic of the damaged plastic part. Such a sprayable curable coating would provide an economical solution to both the repair need and the supply chain shortage of the new plastic parts. Further, there is currently no sprayable curable coating that matches multiple textures, wherein in situations where multiple textures are needed for repair of plastic vehicle body parts and/or construction/agricultural implements or equipment. Repair is difficult as there is some variety in the textures (e.g., fineness or coarseness of texture, etc.) that are molded into the plastic parts. Additionally, there is currently no sprayable curable coating that can form a truck bed line, and/or provide desirable physical properties associated with spray applied bed liners, including substrate adhesion, high crack and abrasion resistance, and/or weather resistance to ultra violet (UV).

### SUMMARY

The present disclosure relates to a curable coating comprising a mixture of a resin component comprising a polyol, a solvent, and an organotin catalyst, the resin component further comprises at least one high T_{g} hydroxyl-functional polymer and at least one low T_{g} hydroxyl-functional polymer. The mixture further comprising wax particles, silica particles, and a curing agent comprising an aliphatic isocyanate.

The present disclosure also relates to a method of forming a curable coating, the method comprising providing a mixture of a resin component, wax particles, and silica particles. The resin component comprising polyurethane, a polyol, a solvent, a high T_{g} hydroxyl-functional polymer and an organotin catalyst, wherein the high T_{g} is greater than 25° C. The wax particles comprising polyethylene particles, and the silica particles comprising a surface treated silica having a median particle size less than 6 μm. The mixture for combining with a curing agent to create a curable coating, the curable coating for spraying onto a surface of a substrate to generate a controlled texture utilizing a spraying apparatus for spraying at a curable pressure between 30 psi and 50 psi.

The present disclosure additionally relates to a method of utilizing a curable coating, the method comprising spraying a first layer of curable coating onto a textured surface utilizing a spraying apparatus, the spraying apparatus for spraying at a curable pressure between 30 psi and 50 psi, the first layer of the curable coating comprising a resin component comprising a polyol, a solvent, and an organotin catalyst, the resin component further comprising a high T_{g} hydroxyl-functional polymer and a low T_{g} hydroxyl-functional polymer, wherein the high T_{g} is greater than 25° C. and the low T_{g} is less than 20° C., the curable coating further comprising wax particles, silica particles and a castor oil derivative. The method further comprising spraying a second layer of the curable coating onto at least a portion of the first layer and spraying one or more additional layers of the curable coating onto at least one of the textured surface or a proceeding layer to obtain a textured film comprised of the curable coating having a thickness of between about 20 and about 30 mils.

The present disclosure additionally relates a curable coating blend comprising a colorant for adding a pigment to a film formed by the curable coating, wax particles having a mean particle size between 9 μm to 11 μm, and silica particles comprising a surface treated silica having a median particle size less than 6 μm. The curable coating blend further comprising a resin component a curing agent. The resin component being substantially free of reactive amine functionality and comprising a polyol blend comprising one or more acrylic polyols, wherein at least one of the acrylic polyols comprises a high T_{g} acrylic polyol, wherein the high T_{g} is greater than 25° C., a castor oil derivative, a polyester polyol, a solvent, an organotin catalyst, and a UV light stabilizer.

### BRIEF DESCRIPTION OF THE DRAWINGS

The foregoing and other features and advantages of the present disclosure will become apparent to one skilled in the art to which the present disclosure relates upon consideration of the following description of the invention with reference to the accompanying drawings, wherein like reference numerals, unless otherwise described refer to like parts throughout the drawings and in which:

FIG. 1 illustrates a method of making a curable coating in accordance with one example embodiment of the present disclosure; and

FIG. 2 illustrates a method of using a curable coating in accordance with one example embodiment of the present disclosure.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present disclosure.

The apparatus and method components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

### DETAILED DESCRIPTION

Referring now to the figures wherein like numbered features shown therein refer to like elements throughout unless otherwise noted. The present disclosure relates generally to a curable coating comprising a sprayable polyurethane, texture coating compositions and associated methods of application thereof and, more specifically, curable coatings to repair and/or add textures to substrates. Sprayable polyurethane coating compositions and methods of application of the present disclosure may be advantageously utilized for repair of plastic vehicle body parts, as well as providing protection and/or corrosion resistance for vehicles and/or construction/agricultural implements or equipment. By way of example and without limitation, sprayable polyurethane coating compositions and methods of application may be used for repair of plastic parts on vehicles wherein texture matching to the texture(s) of the OEM part is desired and for application to truck beds and other surfaces where coating for surface protection and/or improved corrosion resistance is desired.

According to one embodiment of the present invention, a curable coating, such as a textured polyurethane coating composition, comprises a resin component and a curing component, a wax particle and a silica particle, in conjunction, optionally, with one or more additives selected from solvents, light stabilizers, catalysts, dispersants, anti-settle agents and/or a surface tension modifier, which, when mixed together comprise a coating blend suitable for spraying onto a substrate, in one or more layers, to form a polyurethane film having a total thickness of up to about 30 mils.

In another example embodiment of the invention, the curable coating further include a colorant and/or include a suitable pigment dispersion, to provide a colored or tinted textured coating.

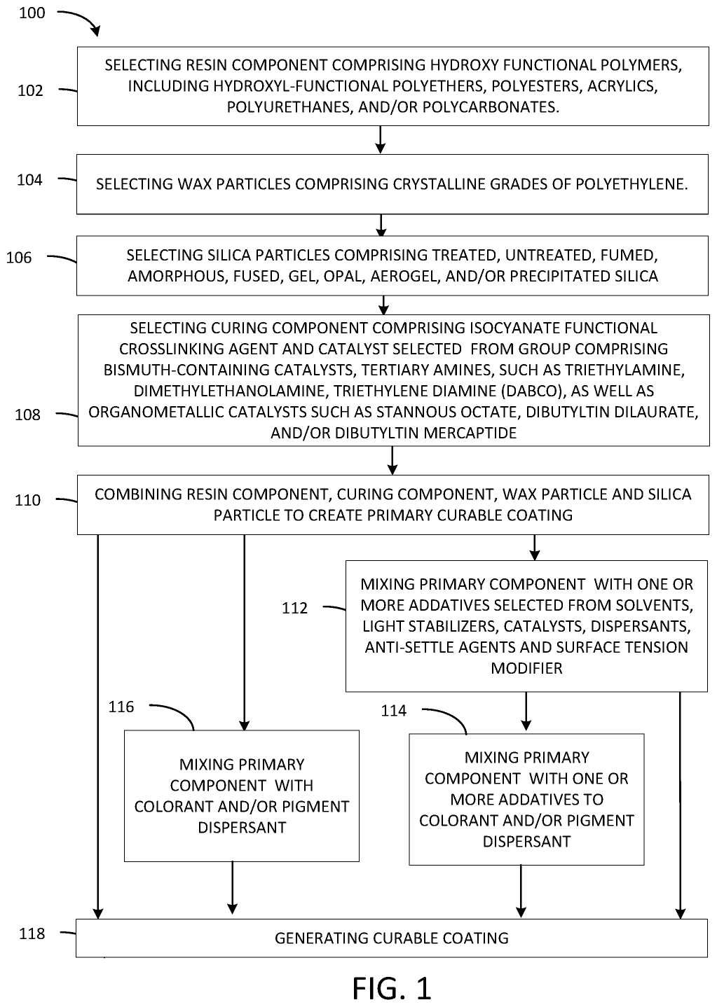

As illustrated in the example embodiment of FIG. 1 illustrating a method 100, of making a curable coating, at 102 the resin component is selected. In this example embodiment, the resin component comprises hydroxy functional polymers, including hydroxyl-functional polyethers, polyesters, acrylics, polyurethanes, and/or polycarbonates. In one example embodiment, the resin component includes at least one high T_{g} hydroxyl-functional polymer, at least one low T_{g} hydroxyl-functional polymer, at least one castor oil derivative and/or include a hydroxyl-functional polyester. In one example embodiment, high T_{g} is greater than 25° C. In another example embodiment, high T_{g} is greater than 40° C. In yet another example embodiment, high T_{g} is greater than 50° C. In one example embodiment, low T_{g} is less than 20° C. In another example embodiment, low T_{g} is less than 5° C. In yet another example embodiment, low T_{g} is less than −5° C. In one embodiment of this example, the high T_{g} hydroxyl-functional polymer is above ambient temperature and the low T_{g} hydroxyl-function polymer is below ambient temperature. In one embodiment of this example, the castor oil derivative has a hydroxyl group number (—OH #) above 140 and/or between 2 and 6 hydroxyl groups per molecule. In one embodiment of this example, the castor oil derivative having —OH #s above 260 and polyols, such as, diols, triols, and tetrols, are contemplated for use.

Suitable hydroxyl-functional polymers within the classes of molecules defined by the respective polymer back bones (polyether, polyester, acrylic, polyurethane, and polycarbonate), and methods of preparing suitable hydroxyl functional polymers within each class, are well known in the art. In one example embodiment, linear and/or branched polyols are utilized in the resin component.

In one example embodiment, the resin component comprises a blend of an at least one high T_{g} hydroxyl-functional polymer, at least one low T_{g} hydroxyl-functional polymer, at least one castor oil derivative and/or include a hydroxyl-functional polyester. In another example embodiment, the high T_{g} hydroxyl-functional polymer is acrylic, the low T_{g} hydroxyl-functional polymer is acrylic, the castor oil derivative is tetra-functional and/or the hydroxyl-functional polyester is linear and saturated.

Example of suitable high T_{g} acrylic polymers include Joncryl® 587, T_{g}=63° C., from BASF Corporation, Arolon 6465, T_{g}=59° C. from Polynt, Setalux 17-1609, T_{g}=47° C. from Allnex and Eterac 73013-X-60 T_{g}=55° C. from Eternal Chemical Company. Example of suitable low T_{g} acrylic polymers include Setalux® 27-1026, T_{g}=0-5° C., from allnex, Joncryl 920 T_{g}=−7° C. from BASF Corporation, Eterac 73006-S-80 T_{g}=16° C. from Eternal Chemical Company. Example of suitable castor oil derivatives include Polycin M-365 from Vertellus, Polycin M-280 which is 4 functional and has an —OH # of 280 and Polycin T-400, which is trifunctional, and has an —OH # of 400. In one example embodiment, the high —OH # is greater than 140. In another example embodiment, the high —OH # is greater than 250. In yet another example embodiment, the high —OH # is greater than 350. Typical acrylic resins range from —OH #56 to 140.

With reference to total dry polyol in the resin component, in one example embodiment, the resin component comprise from between about 20 to about 60 weight percent, of the high T_{g} acrylic polyol, 20 to about 60 weight percent, of the low T_{g} acrylic polyol, 20 to about 60 weight percent, of the castor oil derivative polyol and/or 0-15 weight percent polyester polyol. In another example embodiment, with respect to total dry polyol in the resin component, the resin component comprises from between about 20 to about 50 weight percent, of the high T_{g} acrylic polyol, 20 to about 50 weight percent, of the low T_{g} acrylic polyol, 20 to about 50 weight percent, of the castor oil derivative polyol and/or 2-12 weight percent polyester polyol.

In another example embodiment, with respect to total dry polyol in the resin component, the resin component comprises from between about 40 to about 50 weight percent, of the high T_{g} acrylic polyol, 20 to about 30 weight percent, of the low T_{g} acrylic polyol, 20 to about 30 weight percent, of the castor oil derivative polyol and/or 5-10 weight percent polyester polyol.

At 104 of method 100 in FIG. 1, the wax particle is selected. In this example embodiment, the wax particle comprises crystalline grades of polyethylene. One example of a suitable wax particles include S-395 SP5 from Shamrock. In one example embodiment, the wax particle has a high melt point, insolubility, narrow particle size distribution, hardness, scuff and abrasion resistance. In one example embodiment, the high melt point is greater than 60° C. In one example embodiment, the high melt point is greater than 80° C. In one example embodiment, the high melt point is greater than 120° C. In this example embodiment, the melt point is 126° C.

At 106 of method 100 in FIG. 1, the silica particle is selected. In this example embodiment, the silica particles comprise treated, untreated, fumed, amorphous, fused, gel, opal, aerogel, and/or precipitated silica. Example of suitable silica particles include Lanco® Matt 2000 from Lubrizol, and Aerosil 200 from Evonik, Hi-Sil T-600 from PPG, Perkasil SM600 and Syloid 308 both from W. R. Grace. In one example embodiment, the silica particle has high dispersibility, scratch and mar resistance and prevents formation of hard-settlement. The wax and the silica particles improve the performance of the curable coating for hardness, scuff resistance, wear resistance, mar resistance and the like as compared to resin alone

In one example embodiment, the curable coating, after the resin component, the wax particle and the silica particle are combined, but before the curing component is added, includes the resin component comprising from between about 10 to about 40 weight percent, of the wax particles and 1 to about 9 weight percent, of the silica particles. In another example embodiment, the curable coating after the resin component, the wax particle and the silica particle are combined includes, with respect to total resin component, from between about 15 to about 35 weight percent, of the wax particles and 2 to about 8 weight percent, of the silica particles.

In yet another example embodiment, the curable coating after the resin component, the wax particle, and the silica particle are combined, but before the curing component is added, includes, with respect to total resin component, wax particle, and the silica particle mixture, comprises from between about 20 to about 30 weight percent, of wax particles and 3 to about 7 weight percent, of silica particles.

At 108 of method 100 in FIG. 1, the curing component is selected to be included in the curable coating. The selection of the curing component is discussed in more detail below. At 110 of method 100 in FIG. 1, the resin component, curing component, wax particle, and silica particle are combined to create a primary curable coating.

In one example embodiment of optional step 112 of method 100 in FIG. 1, the resin component and/or the primary curable coating is mixed with an effective amount of a solvent or a solvent blend (as describe in greater detail below) to adjust the viscosity of the resin component so as to make the resulting curable coating sprayable at a sprayable pressure. For purposes of the present disclosure, the effective amount of solvent is an amount which adjusts a viscosity of the curable coating to a level so as to be sprayable at the sprayable pressure and to achieve a desired texture. In one example embodiment, the sprayable pressure is less than about 100 psi. In another example embodiment, the sprayable pressure is less than about 50 psi. In yet another example embodiment, the sprayable pressure is less than about 35 psi. One example of suitable solvents are industrial solvents, including, ethers, esters, ketones, glycols, aliphatic and aromatic hydrocarbons. Another example of the suitable solvent includes glycol ethers, such as ethylene glycol dimethylether, propylene glycol dimethyl ether, glycol ether esters, such as ethylglycol acetate, butyl glycol acetate, 3-methoxy-n-butyl acetate, butyl diglycol acetate, methoxypropyl acetate, esters, such as ethyl acetate, butyl acetate, isobutyl acetate, amyl acetate, ketones, such as acetone, methyl ethyl ketone, methyl isobutyl ketone, methyl amyl ketone, hexane, heptane, cyclohexanone and/or isophorone. In one example embodiment, substantially all of the solvent is included within the resin component. In another example embodiment, all or a portion of the solvent is included in the curing component and/or the colorant.

In another example embodiment of the optional step 112 of method 100 in FIG. 1, the resin component and/or the primary curable coating is mixed with one or more conventional additives, which function as hindered amine light stabilizers (HALS), benzotriazole-type UV light absorbers (UVAs), catalysts, dispersants, anti-settle agents and/or surface tension modifier.

In one example embodiment, the UV light stabilizers, including HALS, and/or UVAs are included in the resin component. Examples of suitable HALS and UVAs are sold under the trade name Tinuvin® available from BASF Corporation. Additional examples of suitable UVAs include UVA Tinuvin 1130, Tinuvin 384-2 from BASF Corporation Chisorb 328 from Chitec, Eversorb 75 from Everlight Chemical Industry Corporation. Additional examples of suitable HALS include Tinuvin 292 from BASF Corporation and ACUV 123 from aalchem.

In another example embodiment of the optional step 112 of method 100 in FIG. 1, catalysts are added, in conventional amounts, to one of the resin component, the curing component, and/or to the primary curable coating to catalyze a crosslinking reaction in the curable coating. Example catalysts include bismuth-containing catalysts, tertiary amines, such as triethylamine, dimethylethanolamine, triethylene diamine (dabco), as well as organometallic catalysts such as stannous octate, dibutyltin dilaurate, dibutyltin mercaptide and/or the like. In another example embodiment, organometallic catalysts comprise the catalyst. In yet another example embodiment, organotin catalysts comprise the catalyst. In another example embodiment, dibutyltin dilaurate comprises the catalyst.

In yet another example embodiment of the optional step 112 of method 100 in FIG. 1, anti-settle agents are added to the primary curable coating. In this example embodiment, the anti-settle agents increase shelf stability and prevent hard packing during storage, which increases an ease of mixing. Examples of suitable anti-settle agents include organo-modified Bentonite and/or Montmorilonite clays, Bentone® 34, Bentone SD®-2, M-P-A®14 available from Elementis Specialties. In this example embodiment, other organic rheology modifiers are optionally used with organo-clays. Examples of suitable organic rheology modifiers include Suspeno 70MS, Suspeno 201 NBA, Suspeno 201-X from Poly-Resyn, Inc.

In yet another example embodiment of the optional step 112 of method 100 in FIG. 1, a surface tension modifier is added to the resin component the curing component (discussed in greater detail below), and/or the primary curable coating, to wet the substrate of a surface that is to receive the curable coating and/or multiple application layers of the curable coating thereto. Examples of suitable surface tension modifiers include BYK-320, BYK-325, BYK-306 and BYK-333 etc., available from BYK-Chemie USA, Inc. Any of the optional steps 112 are contemplated as being performed in isolation or in any possible combination thereof.

In one example embodiment of optional step 114 of method 100 in FIG. 1, a pigment dispersant is added to a resin, wax, silica mixture of the resin component, and/or a mixture generated from combining any of the optional steps at 112. In this example embodiment, the pigment dispersant is added to the wax particles, silica particles, and in some instances the colorants. In one example embodiment, the pigment dispersant is present in the resin, wax, silica mixture to wet and stabilize the wax particles and silica particles, and the colorants, when the colorants are present. Examples of suitable pigment dispersants include Disperbyk® 161, Disperbyk® 170, Disperbyk® 110, BYK® Anti Terra U etc., available from BYK-Chemie USA, Inc. Any of the optional steps 114 are contemplated as being performed in isolation or in any possible combination thereof.

In one example embodiment of optional step 116 of method 100 in FIG. 1, the pigment dispersant and/or the colorant is added to a resin, wax, silica mixture of the resin component, and/or the primary curable component. Any of the optional steps 116 are contemplated as being performed in isolation or in any possible combination thereof.

Other additives that are present in various embodiments include plasticizers, flame-retardants, anti-static agents, fungicides, and/or bacteriocides.

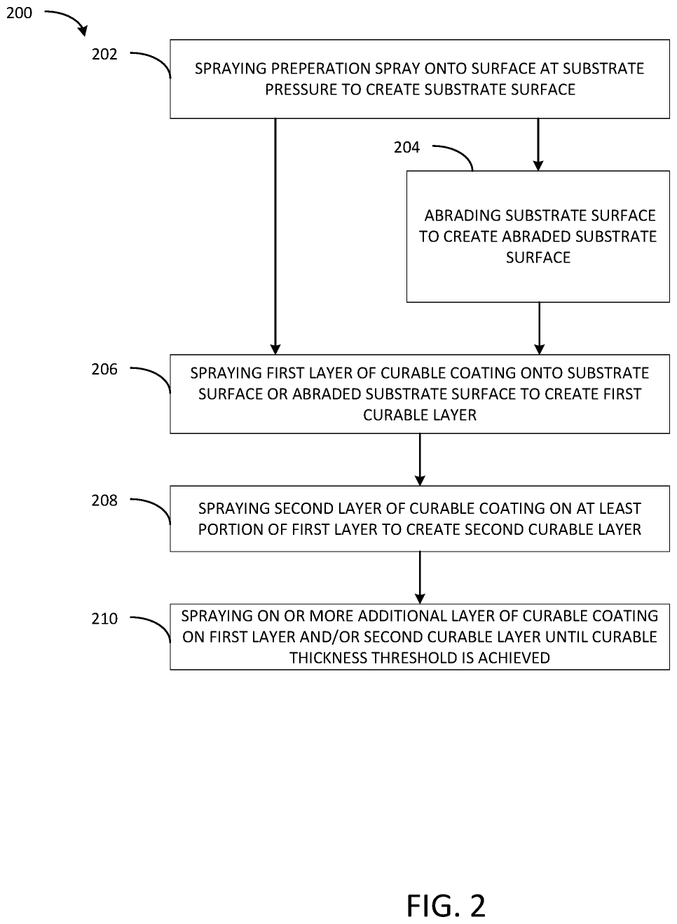

Referring to the curing component discussed above, in one example embodiment, the curing component includes polyisocyanates, isocyanate coatings, or mixtures thereof. Examples of isocyanates suitable for use in this example embodiment include aliphatic, alicyclic, arylaliphatic, aromatic, and heterocyclic polyisocyanates, or combinations thereof. In another example embodiment, the isocyanate or mixture thereof is suitable wherein said isocyanate or mixture thereof is capable of being sprayed at the sprayable pressure as utilized in a method 200 of spraying the curable coating illustrated in FIG. 2. In one example embodiment, suitable isocyanates include those having the formula Z(NCO)n in which n=2-5. In another example embodiment, suitable isocyanates include those having the formula Z(NCO)n in which n=n=2-4. In one example embodiment, Z is one or more of an aliphatic hydrocarbon group containing 2-18 carbon atoms, an alicyclic hydrocarbon group containing 4-15 carbon atoms, an arylaliphatic group containing 8-15 carbon atoms, or an aromatic hydrocarbon group containing 6-15 carbon atoms. In another example embodiment, Z is one of an aliphatic hydrocarbon group containing 6-10 carbon atoms, an alicyclic hydrocarbon group containing 5-10 carbon atoms, an arylaliphatic group containing 8-13 carbon atoms, or an aromatic hydrocarbon group containing 6-13 carbon atoms.

Examples of suitable isocyanates include ethylene diisocyanate, 1,4-tetramethylene diisocyanate, 1.6-hexamethylene diisocyanate (HDI), trimethyl hexamethylene diisocyanate, 1,12-dodecane diisocyanate, cyclobutane-1,3-diisocyanate, cyclohexane-1,3-diisocyanate, cyclohexane-1,4-diisocyanate, diisocyanate-3,3,5-trimethyl-5-isocyanatomethyl cyclohexane, 2,4-toluene diisocyanate, 2,6-toluene diisocyanate, diphenylmethane-2,4′-diisocyanate, diphenylmethane-4,4′-diisocyanate, naphthalene-1,5-diisocyanate, triphenylmethane-4,4′,4′-triisocyanate, isophorone diisocyanate (IPDI), polymethylene polyphenylene polyisocyanates, m- and pisocyanatophenyl Sulfonyl isocyanates, perchlorinated aryl polyisocyanates, norbornane diisocyanates, polyisocyanates containing carbodiimide groups, polyisocyanates containing allophanate groups, polyisocyanates containing isocyanurate groups, polyisocyanates containing urethane groups, polyisocyanates containing biuret groups, polyisocyanates produced by telomerization reactions, polyisocyanates containing ester groups, polyisocyanates containing polymeric fatty acid esters, reaction products of the above-mentioned diisocyanates with acetals, and/or mixtures thereof. In one example embodiment, distillation residues (e.g., such as residues obtained in the commercial production of isocyanates) having isocyanate groups are used alone or in solution in one or more of the above-mentioned polyisocyanates.

In one example embodiment, the isocyanates comprise aliphatic isocyanates having a % Nitrogen-Carbon-Oxygen (NCO) content of about 10% to about 23%. In this example embodiment, the aliphatic isocyanates include HDI and IPDI trimers and/or blends thereof. In one example embodiment, the aliphatic isocyanate is a hexamethylene diisocyanate trimer. Suitable example diisocyanate trimers are the hexamethylene diisocyanate trimer sold as Tolonate HDT or HDT LV and isophorone diisocyanate trimer sold as Tolonate IDT-70 by Vencorex Chemicals. In one example embodiment, mixtures of aliphatic isocyanates and aliphatic and aromatic isocyanates are used. In another example embodiment, such as when the aliphatic isocyanate is the diisocyanate trimer, the aromatic isocyanates comprises less than or equal to 25% by weight of the isocyanate portion of the curable coating. In other example embodiments, the curable coating is substantially free of aromatic isocyanates.

While the additives described above have largely been described in connection with their use in the resin component, it will be recognized by one of ordinary skill that all or portions of certain additives would also or alternatively be contained in the curing component and/or added to the curable coating resulting from any one of steps 110-118 of method 100.

At 118 of the method 100, the curable coating, comprising either the primary curable coating, or some combination generated at optional steps 112-116, is generated.

Notwithstanding, many body shops, automotive refinishing facilities and automotive repair shops and/or dealerships will have access to one or more isocyanate functional curatives due to their widespread use in non-textured polyurethane film applications, and access to a source of colorants, which are discussed in further detail below. Therefore, it is particularly desirable that the resin component be packaged in such a manner as to provide associated users with an efficient way to convert existing sources of colorants and isocyanate curatives. Such as may be available for use in non-textured applications and create with them a textured coating composition that is sprayable at relatively low pressures and produces a film that has excellent performance characteristics.

Thus, in one embodiment the resin, wax, silica mixture comprises one or a blend of polyols, the catalyst, the wax particle, the silica particle, and optionally the light stabilizers, the dispersants, the anti-settle agents, and/or the surface tension modifier in a single package. In one example embodiment, the single package is a conventional quart or gallon metal container.

Advantageously, by packaging the resin, wax, silica mixture in the single package, the associated user can use off the shelf colorants and isocyanate curatives to mix a polyurethane coating blend suitable for forming the curable coating to be sprayed (e.g., at a low pressure such as 35 psi-50 psi). One example the resin, wax, silica mixture single package comprises:
(a) the polyol blend, which in one example is about 20% to about 40%, or, in another embodiment, about 25% to about 35% of total coating solids,
(b) the wax particles, which in one example is about 15% to about 35%, or, in another embodiment, about 20% to about 30% of total coating solids
(c) the silica particles, which in one example is about 2% to about 5%, or, in another embodiment, about 3% to about 7% of total coating solids,
(d) the pigment dispersant, which in one example is from about 0.1% to about 3%, or, in another embodiment, about 0.25% to about 2% of total coating solids, but range further depending on the colorant, and is optional depending on whether the use of colorant is anticipated,
(e) the catalyst, which in one example is about 0.001% to about 0.2%, or, in another embodiment, about 0.05% to about 0.2% of total coating solids,
(f) the light stabilizer, which in one example is 0.1% to about 5%, or, in another embodiment, about 0.5% to about 3% of total polymer resin solids,
(g) the solvent or solvent blend, which in one example is about 5% to about 30%, or, in another embodiment, about 10% to about 20% by total weight of the resin component, and
(h) the surface modifier, in one example is in amounts of 0.001% to 1%, or 0.05% to 1% of total coating solids.

While it is contemplated, in one embodiment, that a substantially clear polyurethane film is formed by mixing the resin component, the silica particles, the wax particles, and curing components and then spraying the resulting polyurethane coating composition onto the substrate, color for the curable coating is contemplated. Thus, it is contemplated in another embodiment, that the curable coating comprises, in addition to the primary curable coating, generated at method step 120, the colorant. As described in optional steps 114 or 116, the colorant is one or more of a liquid or powder pigment or dye or primer. Liquid colorants are achieved, for example, by mixing pigments into a lacquer. Pigments and other colorant sources used in conventional automotive finishing are used when the curable coating is to be used to repair textured substrates, add desired textures to substrates, and/or form sprayable vehicle bedliners. By using conventional automotive colorants, it is possible to match or augment the color of the texture coating to the base color coat of the associated vehicle or vehicle parts. Examples of suitable toners and blends of colorant are the No-Mix® Low VOC Refinish System and Paladin products available from Transtar Autobody Technologies.

To form a textured coating, the primary curable coating (or any curable coating resulting from optional steps 112-116) and, optionally, colorant, are mixed together to form a substantially homogeneous blend comprising the curable coating. Methods of mixing include mixing by hand or by shaker, though any conventional mixing method may be used. In one example embodiment, a color blend comprises, pre-mixing the colorant from 5% to 20% by volume to 95% to 80% resin, wax, silica mixture by volume to generate a tinted resin component. Then, further mixing by volume, approximately 5 parts of the above tinted resin component and two parts of the curing component; however, variation from this ratio is contemplated.

To achieve the curable coating (e.g., a film-forming coating blend), a sufficient amount of the curing component to provide at least one to one (1.0:1.0) ratio of total isocyanate groups (—NCO) in the curing component to the hydroxyl groups (—OH) in the resin component is utilized. In another embodiment, at least a one to one (1.0:1.0) ratio of total isocyanate groups (—NCO) in the curing component to the hydroxyl groups (—OH) and other active hydrogen-containing compounds, such as amine groups in the resin component are utilized.

As illustrated in the example embodiment of FIG. 2 illustrating a method 200, of using the curable coating, at 202, a preparation spray is sprayed on to a surface at a substrate pressure (e.g., between around 15 psi to about 50 psi) to create a substrate surface.

At optional step 204 of the method 200, the substrate to be sprayed is prepared for spraying of the coating composition by abrasion or scuffing. In one example embodiment, the abrasion or scuffing is generated with a grinder or abrasive paper. In another example embodiment, the abrasion or scuffing is performed to clean a surface of the substrate and/or rid the surface of contaminants (e.g. chipping or peeling paint, rust) that might show through a film comprised of the curable coating. In one example embodiment, the preparation spray is an adhesive primer coat to achieve suitable adhesion on TPO substrates. In one example embodiment, such as on metal substrates, the preparation spray is a rust inhibiting layer that is applied to the substrate.

As indicated, an example substrate is a vehicle panel, such as the rocker area, plastic bumper, plastic trim, mirror shell, wheel-well liner and/or truck bed. Plastic or metal substrates, interior or exterior are also substrates, when a textured coating is desired.

At 206-210, the curable coating is applied to the substrate using a variety of techniques, including brushing, rolling and dipping. The curable coating are suitable for low pressure spray applications (as discussed in detail below). Suitable examples of low pressure spray apparatuses, which are able to spray at a curable pressure, include Schutz style or HVLP spray guns in conjunction with properly associated compressors. In one example embodiment, a curable pressure for application of the curable coating is less than about 100 psi. In another example embodiment, the curable pressure is less than about 50 psi. In another example embodiment, the curable pressure is less than about 35 psi. In yet another example embodiment, the curable pressure is between about 30 psi and about 100 psi. In yet another example embodiment, the curable pressure is about 30 psi to 75 psi. In yet another example embodiment, the curable pressure is about 30 psi to about 50 psi. The curable pressure is at typical ambient environmental conditions and temperatures.

At 206 of the method 200, a first layer of the curable coating is sprayed onto the substrate and/or the abraded substrate surface. At 208 of the method 200, a second layer of curable coating is applied to at least a portion of the first layer. At 210, one or more additional layers of the curable coating are applied to the first and/or second layer until a curable thickness threshold is achieved. In one example embodiment, the curable thickness threshold comprises a visual texture match to a surrounding surface. In one example embodiment, the texture is adjusted to match the substrate. In another example embodiment, the curable coating, starting from 20 psi, increasing air pressure, in 5-10 psi increments, reduces the coarseness of the texture. Also, additional reduction by solvent or solvent blend to the primary curable coating and/or curable coating generated with the various additives of optional steps 114 and 116, in 5-10% increments, reduces the coarseness of the texture. Additionally, reducing a tip size of the spray gun reduces the coarseness of the texture, wherein tip sizes ranging from 2.2 mm to 1.3 mm are available in vehicle repair shops, while even smaller tips are available, though less common to find. It is apparent to those skilled in the art how to make these adjustments, individually or in combination, to match the desired textures. Advantageously, for example, the second layer of the curable coating is sprayed onto the first layer while the first layer is still tacky. Additionally, a spray gun to substrate distance during application is adjustable to generate the desired textures. In one example embodiment, the desired texture is created, by starting the first layer a distance of about 6 inches from the substrate, the second layer from about 12 inches from the substrate and, if desired, a third layer of the one or more additional layers at about 18 inches from the substrate. It would be apparent to one of ordinary skill in the art how to use the spray gun to substrate distance to match the desired textures. In another example embodiment, layers subsequent to the first or second layer are sprayed onto previously applied layers after the latter have substantially fully cured. In this example embodiment, the fully cured layer is mildly scuffed, abraded, or otherwise sanded prior to application of the subsequent layer. Layers have the same or different colors, which, in some embodiments, allow for the creation of stenciled designs or other multi-color designs.

The following examples further illustrate details of the preparation and use of the compositions of the present disclosure. The disclosure is not intended to be limited by these specific examples, however. All parts and percentages are by weight unless otherwise specified.

### Examples

TABLE 1

| | | Composition | | | |
|---|---|---|---|---|---|
| Component | Volume Ratio | Chemistry | Functions | Weight | Sub-total |
| II | 5 | Acrylic resin 1 | Resin | 28.67 | 100 |
| | | Acrylic resin 2 | Resin | 9.66 | |
| | | Castor oil derivative | Resin | 7.09 | |
| | | Polyester | Resin | 2.58 | |
| | | Solvent mixture | Diluent | 13.21 | |
| | | Pigment dispersant | Pigment wetting | 0.32 | |
| | | Surface active agent | Substrate wetting | 0.15 | |
| | | Dibutyltin dilaurate | Catalyst | 0.64 | |
| | | Bentonite clay | Anti-settle agent | 1.61 | |
| | | Organic Rheology Modifier | Anti-settle agent | 2.25 | |
| | | HALS | UV stabilizer | 0.97 | |
| | | UVA | UV stabilizer | 0.97 | |
| III | | Wax | Texturing agent | 26.73 | |
| IV | | Treated Silica | Matting agent | 5.15 | |
| V | 2 | Solvent blend | Diluent | 15.40 | 45 |
| | | HDI | Crosslinker | 19.46 | |
| | | IPDI | Crosslinker | 10.14 | |

TABLE 2

| | | Composition | | | |
|---|---|---|---|---|---|
| Component | Volume Ratio | Chemistry | Functions | Weight | Sub-total |
| II | 5 | Acrylic resin 1 | Resin | 28.67 | 100 |
| | | Acrylic resin 2 | Resin | 9.66 | |
| | | Castor oil derivative | Resin | 7.09 | |
| | | Polyester | Resin | 2.58 | |
| | | Solvent mixture | Diluent | 13.21 | |
| | | Pigment dispersant | Pigment wetting | 0.32 | |
| | | Surface active agent | Substrate wetting | 0.15 | |
| | | Dibutyltin dilaurate | Catalyst | 0.64 | |
| | | Bentonite clay | Anti-settle agent | 1.61 | |
| | | Organic Rheology Modifier | Anti-settle agent | 2.25 | |
| | | HALS | UV stabilizer | 0.97 | |
| | | UVA | UV stabilizer | 0.97 | |
| III | | Wax | Texturing agent | 26.73 | |
| IV | | Treated Silica | Matting agent | 4.12 | |
| V | 3 | Solvent blend | Diluent | 22.93 | 67 |
| | | HDI | Crosslinker | 28.97 | |
| | | IPDI | Crosslinker | 15.09 | |

TABLE 3

| | | Composition | | | |
|---|---|---|---|---|---|
| Component | Volume Ratio | Chemistry | Functions | Weight | Sub-total |
| I | 1 | Toner | Colorant | 20.00 | 20 |
| II | 4 | Acrylic resin 1 | Resin | 22.93 | 80 |
| | | Acrylic resin 2 | Resin | 7.73 | |
| | | Castor oil derivative | Resin | 5.67 | |
| | | Polyester | Resin | 2.06 | |
| | | Solvent mixture | Diluent | 10.56 | |
| | | Pigment dispersant | Pigment wetting | 0.26 | |
| | | Surface active agent | Substrate wetting | 0.12 | |
| | | Dibutyltin dilaurate | Catalyst | 0.52 | |
| | | Bentonite clay | Anti-settle agent | 1.29 | |
| | | Organic Rheology Modifier | Anti-settle agent | 1.80 | |
| | | HALS | UV stabilizer | 0.77 | |
| | | UVA | UV stabilizer | 0.77 | |
| III | | Wax | Texturing agent | 21.39 | |
| IV | | Treated Silica | Matting agent | 4.12 | |
| V | 2 | Solvent blend | Diluent | 15.40 | 45 |
| | | HDI | Crosslinker | 19.46 | |
| | | IPDI | Crosslinker | 10.14 | |

TABLE 4

| | | Composition | | | |
|---|---|---|---|---|---|
| Component | Volume Ratio | Chemistry | Functions | Weight | Sub-total |
| I | 1 | Toner | Colorant | 20.00 | 20 |
| II | 4 | Acrylic resin 1 | Resin | 22.93 | 80 |
| | | Acrylic resin 2 | Resin | 7.73 | |
| | | Castor oil derivative | Resin | 5.67 | |
| | | Polyester | Resin | 2.06 | |
| | | Solvent mixture | Diluent | 10.56 | |
| | | Pigment dispersant | Pigment wetting | 0.26 | |
| | | Surface active agent | Substrate wetting | 0.12 | |
| | | Dibutyltin dilaurate | Catalyst | 0.52 | |
| | | Bentonite clay | Anti-settle agent | 1.29 | |
| | | Organic Rheology Modifier | Anti-settle agent | 1.80 | |
| | | HALS | UV stabilizer | 0.77 | |
| | | UVA | UV stabilizer | 0.77 | |
| III | | Wax | Texturing agent | 21.39 | |
| IV | | Treated Silica | Matting agent | 4.12 | |
| V | 3 | Solvent blend | Diluent | 22.93 | 67 |
| | | HDI | Crosslinker | 28.97 | |
| | | IPDI | Crosslinker | 15.09 | |

In various example embodiments, the curable coating is prepared as shown in Tables 1-4 (above) with the colorant/toner (Component I) as in Tables 3-4, the resin component (Component II), the wax particles (Component III), the silica particles (Component IV) and the curing component (Component V). In these example embodiments, the resin component (Component II) are prepared by blending all of the listed ingredients in a high speed disperser for 60 minutes at 5000 rpm, this includes the wax particles (Component III) and the silica particles (Component IV). The colorant (when indicated by the tables), the mixture of components II, III, and IV, and component V are then added into a can (e.g., such as a metal can) and mixed by a shaker mixer for 10 minutes.

The curable coatings formed from the compositions described herein, show excellent resistance to solvents, such as oil and gasoline. Further, the curable coatings have UV resistance without utilizing a separate UV topcoat. Additionally, the curable coatings have excellent physical characteristics, including scratch and mar resistance, desirable slip for easy loading and unloading in a bed and/or are smooth to the touch on interior parts. It will be apparent to those skilled in the art that the above methods and apparatuses may incorporate changes and modifications without departing from the general scope of this invention. It is intended to include all such modifications and alterations in so far as they come within the scope of the appended claims or the equivalents thereof.

Advantageously, the curable coating described herein is used in conventional spray equipment such as a Shutz type spray gun or an HVLP spray gun, at conventional pressures. This makes curable coating cost effective for typical body shops, auto retailers and auto detailers to use their market demand level, without dedicating the entire business to textured protective coatings and the associated cost of high pressure equipment. The use of conventional equipment at conventional spraying pressures, allows smaller or non-specialized auto body shops to repair textured body parts of plastic and metal substrates, extend the service life of a vehicle by adding a layered of textured coating, improve the appearance of the vehicle with a texture, or further customize the looks of the vehicle, in particular Sport Utility or off-road vehicles, with the curable coating.

In the foregoing specification, specific embodiments have been described. However, one of ordinary skill in the art appreciates that various modifications and changes can be made without departing from the scope of the disclosure as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The disclosure is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. In one non-limiting embodiment the terms are defined to be within for example 100%, in another possible embodiment within 5%, in another possible embodiment within 1%, and in another possible embodiment within 0.5%. The term “coupled” as used herein is defined as connected or in contact either temporarily or permanently, although not necessarily directly and not necessarily mechanically. A device or structure that is “configured” in a certain way is configured in at least that way, but may also be configured in ways that are not listed.

It should be appreciated by those of ordinary skill in the art after having the opportunity of reviewing the drawings and/or specification of the present disclosure that it may include one or more embodiments, e.g., E₁, E₂, . . . Eₙ and that each embodiment E may have multiple parts A₁, B₁, C₁ . . . . Zₙ that (without further description) could be combined with other embodiments Eₙ, embodiment parts e.g. A₁, C₁, or lack of parts originally associated with one or all embodiments E n, or any combination of parts and/or embodiments thereof. It should further be appreciated that an embodiment Eₙ may include only one part e.g. A₁ or a lesser number of parts e.g. B₁, C₁ of any embodiment or combination of embodiments that was described or shown in the specification and/or drawings, respectively in ways not enumerated or illustrated.

To the extent that the materials for any of the foregoing embodiments or components thereof are not specified, it is to be appreciated that suitable materials would be known by one of ordinary skill in the art for the intended purposes.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A curable coating comprising a mixture of:
a resin component comprising a polyol, a solvent, and an organotin catalyst, the resin component further comprises at least one high T_{g} hydroxyl-functional polymer and at least one low T_{g} hydroxyl-functional polymer;
wax particles;
silica particles; and
a curing agent comprising an aliphatic isocyanate.

2. The curable coating of claim 1, wherein the curable coating mimics a textured surface to which it is applied, wherein the textured surface is on vehicle.

3. The curable coating of claim 1, the resin component comprise from between 20 to 60 weight percent of the high T_{g} hydroxyl-functional polymer and 20 to 60 weight percent of the low T_{g} hydroxyl-functional polymer relative to a total dry polyol in the resin component.

4. The curable coating of claim 1, wherein the polyol further comprises a castor oil derivative polyol that has a hydroxyl functionality between 2 and 6 and molecular weight between 400 g/mol and 1200 g/mol.

5. The curable coating of claim 1, the polyol comprises an acrylic polyol, further wherein, the resin component comprises from between 20 to 60 weight percent of a high T_{g} acrylic polyol and 20 to 60 weight percent of a low T_{g} acrylic polyol relative to a total dry polyol in the resin component, wherein the high T_{g} is greater than 25° C. and the low T_{g} is less than 20° C.

6. The curable coating of claim 5, wherein the wax particle comprises:
greater than ninety five percent (95%) polyethylene particles of less than 35 μm in size;
a mean particle size between 9 μm to 11 μm; and
a melt point greater than 100° C.

7. The curable coating of claim 5, further comprising a castor oil derivative.

8. The curable coating of claim 5, wherein the curable coating further comprises a castor oil derivative having a hydroxyl group number greater than 260.

9. The curable coating of claim 1, wherein the polyol further comprises a polyester polyol.

10. The curable coating of claim 1, wherein the curable coating further comprises a castor oil derivative having a hydroxyl group number greater than 140.

11. The curable coating of claim 1, wherein the wax particle comprises at least one of:
greater than ninety five percent (95%) polyethylene particles of less than 35 μm in size;
a mean particle size between 9 μm to 11 μm; and
a melt point greater than 100° C.

12. The curable coating of claim 1, wherein the silica particle comprises:
a surface treated silica having a median particle size less than 6 μm; and
an oil absorption between 200 ml/100 g to 300 ml/100 g.

13. The curable coating of claim 1, further comprising at least one of a colorant and a pigment dispersant.

14. A method of forming a curable coating, the method comprising:
providing a mixture of a resin component, wax particles, and silica particles, the resin component comprising polyurethane, a polyol, a solvent, a high T_{g} hydroxyl-functional polymer and an organotin catalyst, wherein the high T_{g} is greater than 25° C., the wax particles comprising polyethylene particles, the silica particles comprising a surface treated silica having a median particle size less than 6 μm, the mixture for combining with a curing agent to create a curable coating, the curable coating for spraying onto a surface of a substrate to generate a controlled texture utilizing a spraying apparatus for spraying at a curable pressure between 30 psi and 50 psi.

15. The method of claim 14, wherein the providing the resin component comprises providing a castor oil derivative having a hydroxyl functionality between 2 and 6 and molecular weight between 400 g/mol and 1200 g/mol.

16. The method of claim 14, wherein the providing:
the resin component comprises providing a high T_{g} acrylic polyol and a low T_{g} acrylic polyol, wherein, the resin component comprises from over 20 weight percent of the high T_{g} acrylic polyol and over 20 weight percent of the low T_{g} acrylic polyol relative to a total dry polyol in the resin component, wherein the high T_{g} is greater than 25° C. and the low T_{g} is less than 20° C.; and
the wax particle comprises providing wax particles that have:
greater than ninety five percent (95%) polyethylene particles of less than 35 μm in size;
a mean particle size between 9 μm to 11 μm; and
a melt point greater than 100° C.

17. A method of utilizing a curable coating, the method comprising:
spraying a first layer of curable coating onto a textured surface utilizing a spraying apparatus, the spraying apparatus for spraying at a curable pressure between 30 psi and 50 psi, the first layer of the curable coating comprising a resin component comprising a polyol, a solvent, and an organotin catalyst, the resin component further comprising a high T_{g} hydroxyl-functional polymer and a low T_{g} hydroxyl-functional polymer, wherein the high T_{g} is greater than 25° C. and the low T_{g} is less than 20° C., the curable coating further comprising wax particles, silica particles and a castor oil derivative;
spraying a second layer of the curable coating onto at least a portion of the first layer; and
spraying one or more additional layers of the curable coating onto at least one of the textured surface or a proceeding layer to obtain a textured film comprised of the curable coating having a thickness of between about 20 and about 30 mils.

18. The method of claim 17, further comprising spraying the first layer of the curable coating from a first distance from the textured surface, and spraying the second layer of the curable coating at a second distance, the first distance less than the second distance.

19. A curable coating blend comprising:
a colorant for adding a pigment to a film formed by the curable coating;
wax particles having a mean particle size between 9 μm to 11 μm;
silica particles comprising a surface treated silica having a median particle size less than 6 μm;
a resin component, the resin component being substantially free of reactive amine functionality and comprising a polyol blend comprising one or more acrylic polyols, wherein at least one of the acrylic polyols comprises a high T_{g} acrylic polyol, wherein the high T_{g} is greater than 25° C., a castor oil derivative, a polyester polyol, a solvent, an organotin catalyst, and a UV light stabilizer, and
a curing agent.

20. The curable coating blend of claim 19, wherein the polyol blend comprises a low T_{g} acrylic polyol, wherein the low T_{g} is less than 20° C.

21. The curable coating blend of claim 19, wherein the resin component further comprises at least one of a wetting agent, an anti-settle agent, and a pigment dispersant.
